(19) United States
(12) Patent Application Publication
(10) Pub. No.: US 2010/0056064 A1
(43) Pub. Date: Mar. 4, 2010

(54) APPARATUS FOR MULTI-PARTY CONVERSATION

(76) Inventor: Zhongwen CHEN, Dongguan (CN)

Correspondence Address: SCIHEAD INTELLECTUAL PROPERTY LAW GROUP, LTD, Huihua Commercial & Trade Building, Suite 1508, 80 Xian Lie Zhong Road, Guangzhou, 51070, CN

(21) Appl. No.: 12/198,122

(22) Filed: Aug. 26, 2008

(51) Int. Cl. H04B 7/00

(52) U.S. Cl. 455/66.1

(57) ABSTRACT

An apparatus for multi-party conversation, used for transmitting and exchanging content of conversation, comprising an earphone socket, several connector lead wires and a print circuit plate, wherein the apparatus is connected with various communication devices via said several connector lead wires, and said each connector lead wire has an exchange circuit for control of the radio signals. Utilization of the apparatus increases the number of parties which are capable of joining the conversation simultaneously, and meets the demand of different type of communication devices for participating the multi-party conversation at the same time.

### FIELD OF THE INVENTION

The invention relates to an apparatus for multi-party conversation.

### BACKGROUND OF THE INVENTION

Device for multi-party is well known and widely used in today's society. Although it takes great advantage for people, it has inherently some drawbacks difficult to overcome by prior art technique. One aspect, ongoing conversation has to be paused for a period of time when the number of party asking for participating the multi-party conversation is increased due to insufficiency of connecting devices used for multi-party conversation. The conversation can be resumed again only when one or more party that is waiting for call get(s) access into the conversation, thus resulting in waste of time consumed in waiting and reduction of length of conversation time. The other aspect, limited by function of conventional device for multi-party conversation, all communication devices must be of the same type of such as wireless device or wired device; when different type of communication devices are used, it is needed to introduce an exchange unit to achieve interconnection among these different type of communication devices. For example, an expensive exchange unit is needed to interconnect a telephone communication system and an electronic communication system thus resulting in increasing of operation cost and application difficulty.

Therefore it is desired to provide an apparatus for multi-party conversation such that different type of communication device can be interconnected simultaneously and a multi-system capable of exchanging and transmitting content of conversation is formed to overcome prior art problems.

### SUMMARY OF THE INVENTION

To resolve problems of prior art, an apparatus for multi-party conversation is provided such that different type of communication device can be interconnected simultaneously and a multi-system capable of exchanging and transmitting content of conversation is formed.

One kind of apparatus for multi-part conversation of the invention mainly comprises an earphone socket, several connector lead wires and a print circuit plate, used for transmission and exchange of content of multi-part conversation, wherein the apparatus for multi-part conversation is connected with various communication devices via several connector lead wires, and each connector lead wire has an exchange circuit for control of the radio signals. The object of multi-part and multi-system conversation simultaneously will come true by the said exchange circuit, and introduction of the communication devices takes no effect on ongoing multi-party conversation.

One end of each connector lead wire is electrically coupled to said earphone socket for control of transmission of radio signals and resulting in interconnection among various communication devices. Extended from one exchange circuit inside of the connector lead wire, input circuit, output circuit and ground wire are parallelly disposed and electrically coupled to a leader formed on said connector lead wire. Exchange circuit comprises capacitances, resistances and control switches. Through capacitances and resistances to control the fluctuation of radio signals, control switches can get separate control on transmission of radio signals of each circuit to make it possible for users to participate or leave the meeting at their will without interruption of the meeting.

The exchange circuit on print circuit plate comprises several input circuits, output circuits and a ground wire, wherein each input circuit is in double parallel connection; likewise, each output circuit and ground wire are in double parallel connection. Said exchange circuit is electrically coupled to a jack of the earphone socket separately, which makes exchange circuit of one jack operate independently and connected with each other when the leader is plugged into the jack of the earphone socket. Control of the fluctuation of the radio signals is realized via capacitances and resistances.

Compared with conventional technique, one kind of the apparatus for multi-party conversation of the invention realizes multi-party conversation using different communication devices, increases the number of parties which are capable of joining the conversation simultaneously, and meets the demand of different type of communication devices for participating the multi-party conversation at the same time; on the other hand, as the power input and output circuit for delivering and exchanging content of the multi-party conversation are interconnected each other and separated from each other, interference induced by one or more lated communication device is prevented from effecting conversation between original communication devices, resulting in mutual calling among different communication devices and increasing number of communication devices and conversation parties, resolving the problems existing in conventional technique that only communication device of the same type can be accessed into a multi-party conversation, and that a pause is necessary in conversation when a new party is asking for accessing. In addition, compared with prior art, a record device may be introduced into the apparatus for multi-party conversation for making a recordation of the conversation content for purpose of retrieval in later.

To better understand the invention, the embodiments of the invention will be described in greater detail in conjunction with the drawings.

### DESCRIPTION OF THE DRAWINGS

FIG. 1 is a schematic diagram of the apparatus for multi-party of one embodiment of the invention;

FIG. 2 is a schematic diagram of an earphone socket of one embodiment of the invention;

FIG. 3 shows an inside view of a connector lead wire of one embodiment of the invention;

FIG. 4 shows another inside view of the connector lead wire shown in FIG. 3; and

FIG. 5 shows a schematic inside circuitry of the apparatus for multi-party conversation of one embodiment of the invention.

### DETAILED DESCRIPTION OF THE INVENTION

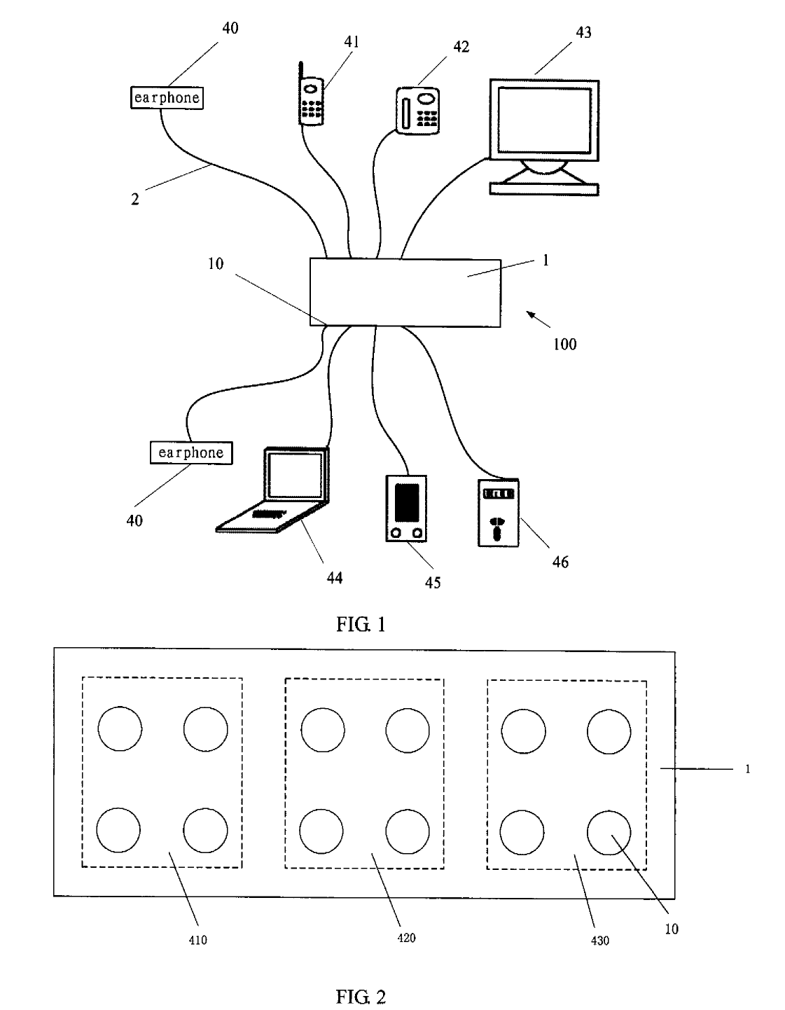

Combined with reference to FIG. 1 and FIG. 2, one kind of apparatus for multi-part conversation of the invention mainly comprises an earphone socket 1, several connector lead wires 2 and a print circuit plate with exchange circuit (not shown in drawings), used for transmission and exchange of content of multi-part conversation, where the apparatus for multi-part conversation is connected with various communication devices via several connector lead wires 2. The object of multi-part and multi-system conversation simultaneously will come true by the said exchange circuit. In the invention, the said communication device are computer system or electronic communication system, for instance, they are optional to be earphone 40, wireless communication device 41, wired communication device 42, table computer 43, laptop 44, megaphone 45 and recorder 46 etc.

FIG. 2 shows earphone socket 1 of one kind of apparatus for multi-part conversation, which comprises several jacks 10, distributed thereon and revealed outside of the apparatus for plug-in of several leaders 20 to make smooth passage of radio signals among each communication device. The said jack 10 can be interface of various communication devices, for instance, to accommodate to the requirements of different users and get match connection with different types of communications devices, the interface of communication device can be interface 410 of wireless communication device 41, interface 420 of wired communication device 42 and interface 430 of computer 43.

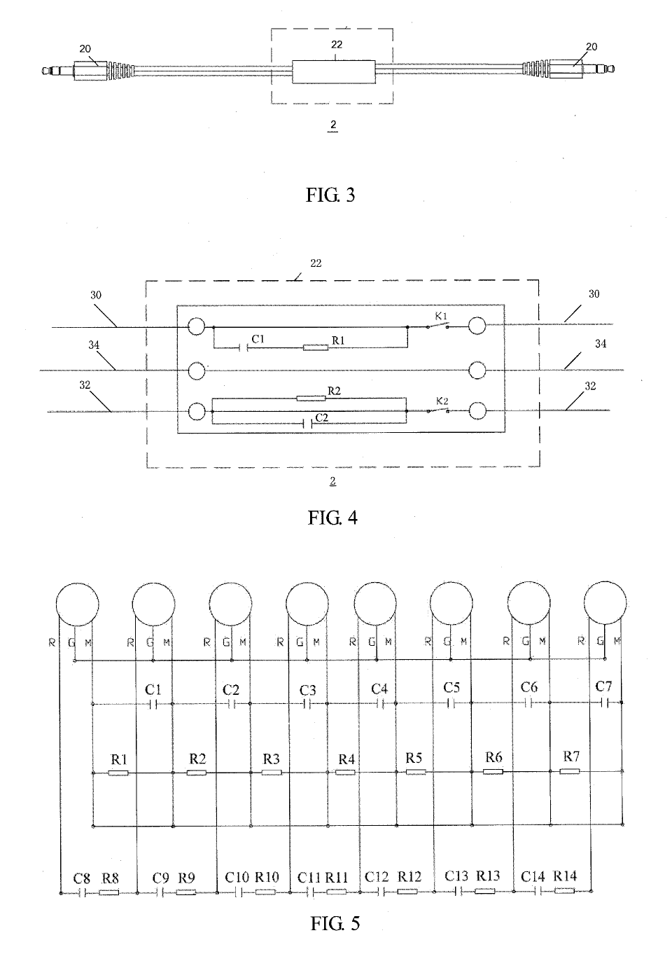

Combined with reference to FIG. 2 and FIG. 3, the connector lead wire 2 is used for control of transmission of radio signals, one point of which has leader 20 and the other point is coupled to the exchange circuit of the print circuit plate, furthermore, the leader 20 can match with the communication device to be connected. Combined with reference to FIG. 3 and FIG. 4, extended from one exchange circuit 22 inside of the connector lead wire 2, input circuit 30, output circuit 32 and ground wire 34 are parallelly disposed and electrically coupled to leader 20. Exchange circuit 22 comprises capacitance(c1, c2), resistance(R1, R2) and control switch(K1, K2) wherein K1 is an earphone switch for control of radio output and K2 is an microphone switch for control of radio input. In exchange circuit 22, firstly, capacitance c1, a resistance R1 and control switch K1 are connected in series, then get connected with radio output circuit 30; After parallel connection, capacitance c2 and resistance R2 are connected with control switch K2 in series and then all coupled to radio input circuit 32. Through capacitance(c1, c2) and resistance(R1, R2) to control the fluctuation of radio signals, control switch K1, K2 can get separate control on transmission of radio signals of each circuit to make it possible for users to participate or leave the meeting at their will without interruption of the meeting.

With reference to FIG. 5, the exchange circuit on print circuit plate used for control of exchange of radio signals comprises several microphone input circuits M, earphone output circuit R and ground wire G, where each input circuit are in double parallel connection and can control the fluctuation of radio signals through capacitance(c1, c2 . . . C7) and resistance(R1, R2 . . . R7); Likewise, each output circuit R are in double parallel connection and can control the fluctuation of radio signals through capacitance(c8, c9 . . . C14) and resistance(R8, R9 . . . R14) to get smooth passage of radio signals among each interface. Each ground wire G is separately in direct double parallel connection with another. Exchange circuit is electrically coupled to jack 10 of earphone socket 1 separately, which makes exchange circuit of one jack 10 operate independently and connected with each other when leader 20 is plugged into jack 10 of earphone socket1.

When the invention is in application, by plugging one point of connector lead wire 2 into jack 10 of earphone socket 1 and connecting the other point with different communication devices through leader 20, transmission and exchange apparatus for multi-part conversation can get electrical connection with different communication devices to make them participate in multi-part conversation at the same time. As radio signals of jack 10 of each point can be input or output in parallel by itself and interflow with other one, the ongoing conversation needn't to be cut off to wait delivery of coming call when the new communication device sends application call for joining the conversation.

The foregoing description is only preferred embodiment of remote communication method and its meeting system of the invention; the scope of claim is certainly not limited to the described. The invention is, therefore, claimed in any of its forms or modifications within the proper scope of the appended claims appropriately interpreted in accordance with the doctrine of equivalents.

What is claimed is:

1. An apparatus for multi-party conversation, used for transmitting and exchanging content of multi-party conversation, comprising:
an earphone socket, several connector lead wires and a print circuit plate, wherein the apparatus for multi-part conversation is connected with various communication devices via said several connector lead wires, and said each connector lead wire has an exchange circuit for control of the radio signals, and introduction of said communication devices takes no effect on ongoing multi-party conversation.

2. The apparatus for multi-party conversation as claimed in claim 1, wherein said exchange circuit of each connector lead wire comprises a radio input circuit, a radio output circuit and a ground wire, all of which are electrically coupled to a lead, said lead being formed on one end of said connector lead wire.

3. The apparatus for multi-party conversation as claimed in claim 2, wherein said radio input circuit and radio output circuit consist of several capacitances, resistances and control switches, wherein said capacitances and resistances are used for control of the fluctuation of the radio signals, and control switches are used for transmission of the radio signals.

4. The apparatus for multi-party conversation as claimed in claim 2, wherein said print circuit plate further comprises an exchange circuit configured by each radio input circuit, radio output circuit and ground wire, all of which are in double parallel connections, wherein said exchange circuit is electrically coupled to said earphone socket, and said lead of the connector lead wire is coupled electrically to a jack which is formed on said earphone socket.

5. The apparatus for multi-party conversation as claimed in claim 4, wherein said print circuit plate has an exchange circuit for control exchange of the radio signals.

6. The apparatus for multi-party conversation as claimed in claim 1, wherein said communication device comprises an electronic communication device.

7. The apparatus for multi-party conversation as claimed in claim 6, wherein communication device may be one or more of a group consisted of earphone, telephone, computer, megaphone and recorder
